(19) United States
(12) Patent Application Publication
(10) Pub. No.: US 2022/0330675 A1
(43) Pub. Date: Oct. 20, 2022

(54) HOUSING WINDOWS IN PERSONAL CARE PRODUCT

(71) Applicant: The Gillette Company LLC, Boston, MA (US)

(72) Inventors: Robert Andrew Kearney, Reading (GB); Paul Leslie Warrick, Reading (GB)

(21) Appl. No.: 17/721,440

(22) Filed: Apr. 15, 2022

Related U.S. Application Data
(60) Provisional application No. 63/177,257, filed on Apr. 20, 2021.

(51) Int. Cl. A45D 27/00; A45D 34/04

(52) U.S. Cl. CPC A45D 27/00; A45D 34/04

(57) ABSTRACT

The present invention is directed to a personal care product including a treatment sheet having a lower surface, a housing including a floor surface and a plurality of columns, and a cavity formed by a volume extending from the lower surface to the floor surface. The volume extends from an inner column wall of the housing. The plurality of columns is formed in a side wall of the housing. The cavity has a height of at least one-fifteenth of a height of the personal care product and/or a height of at least about a height of one of the columns. The columns extend upward from the floor surface of the housing or to a lower ledge of a carrier of the housing. The floor surface is flat or shaped (e.g., a dome or a cone shape). Fluid flows within the cavity, into and out of windows between the columns.

### CROSS-REFERENCE TO RELATED APPLICATIONS

The present application is related to application Ser. No. (63/177,205) filed on the same date and by the same Assignee as the present application, which are not admitted to being prior art with respect to the present invention by its mention in the cross-reference section. This application is incorporated herein by reference in its entirety.

### FIELD OF THE INVENTION

This invention relates to personal care products, and more particularly those products comprising both skin treatment and/or hair removal.

### BACKGROUND OF THE INVENTION

Personal care products described in the prior art are for either skin treatment or hair removal. Some known prior art discloses shavers for removing hair having blades with apertures, whereby the apertures have sharp cutting edges. In other prior art, wet shaving razors have linear blades or electric shavers have cutter systems comprising of shearing blades that move beneath a foil with apertures to cut hairs. It is advantageous to remove debris such as cut hairs and shave preparations collected around the cutting edges of these products not only for hygiene reasons but to allow the product to continue performing efficiently and over a long period of time.

The prior art provides for removal of debris such as hair and shave preparation compositions by allowing fluid (e.g., water) to flow between the blades. However, the disadvantage in many of these products is that the area provided for debris removal is inadequate. For instance, in wet shavers, the area provided for removing debris is within the razor cartridge and in particular, the span between the blades which is very small and oftentimes not all the debris can be removed with rinsing. Users resort to tapping the blades against a hard surface such as a sink. The debris that is stuck between blades affects the subsequent shave performance of the cartridge which can cause unwanted nicks and cuts. In the prior art reference U.S. Pat. No. 10,500,743, which discloses a dry shaver, hair dust is collected in an encapsulated chamber and while two rinse openings are provided beneath the chamber for water to flow through for removal of hair dust, valves are installed within the encapsulated chamber covering these rinse channels, thereby limiting the direction of flow and making the system complex and ultimately inefficient at removing the collected hair dust.

Further, many of the prior art shavers are specifically designed to remove hair and thus generally are not optimized for effective skin treatment purposes.

Those personal care products optimized for, e.g. skin exfoliation or dermaplaning that comprise cutting edges are generally constructed from a metal foil with cutting edges that protrude beyond the surface of the foil. These products generally do not provide a system for rinsing skin flakes and other debris, inclusive of hair.

The metallic foils in the art are generally formed and shaped to provide a convex or domed treatment surface for improving skin contact along curved skin surfaces. The disadvantage of this construction is that the skin contact area is minimal over extended flat body sites, such as the legs or the back resulting in inefficient treatment that takes a long time to complete.

It is desirable to provide an optimized system for debris removal in a personal care product that is optimized for both skin treatment and hair removal.

It is desirable to provide a debris removal structure in a personal care product optimized for both skin treatment and hair removal that comprises structural features such as a flat treatment surface for good skin contact across extended flat body sites.

### SUMMARY OF THE INVENTION

The present invention is directed to a personal care product including a treatment sheet having a lower surface, a housing including a floor surface and a plurality of columns, and a cavity formed by a volume extending from the lower surface to the floor surface.

In one aspect, the volume extends from an inner column wall of the housing.

In another aspect, the plurality of columns is formed in a side wall of the housing.
In yet another aspect, the cavity is empty.
   In other aspects of the present invention, the cavity includes a height H2 of at least one-fifteenth of a height H1 of the personal care product and/or the cavity includes a height H2 at least about a height H3 of one of the plurality of columns.

Still further aspects include that the treatment sheet is flat or brittle.

With respect to other aspects of the present invention embodiments, the plurality of columns extends upward from the floor surface of the housing or the plurality of columns extend to a lower ledge of a carrier of the housing.

In one embodiment, the floor surface is parallel relative to a plane C1 defined by the lower surface.

In another embodiment, the floor surface is angled relative to a plane C1 defined by the lower surface.

In yet other embodiments, the floor surface is flat or shaped. The shaped floor surface includes a dome or a cone shape.

Further still, one or more windows are disposed between the plurality of columns.

In one embodiment, the treatment sheet is proximal to the one or more windows. The treatment sheet is visible from the one or more windows.

In another embodiment, the housing is substantially cylindrical. Still further embodiments allow for fluid flow within the cavity, into and out of the one or more windows.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings.

FIG. 1A depicts a perspective view of an embodiment of a personal care product of the present invention.

FIG. 1B depicts a side view of an embodiment of the upper product end of a personal care product of the present invention.

FIG. 1C depicts a top view of an embodiment of a personal care product of the present invention.

FIG. 2 depicts a perspective view along section A-A in FIG. 1A of an embodiment of an upper product end of a personal care product having housing windows and struts in accordance with the present invention.

FIG. 3 depicts an exploded cross-sectional view taken along section A-A of FIGS. 1A and 1C of an embodiment of an upper handle end of a personal care product having housing windows and struts in accordance with the present invention.

FIG. 4A-4B depict two cross sectional views along A-A and B-B of FIG. 1A, respectively, of an embodiment of an upper handle end of a personal care product having housing windows and struts in accordance with the present invention.

FIG. 5A depicts a perspective view of an alternate embodiment of a personal care product of the present invention.

FIG. 5B depicts an exploded perspective view of an alternate embodiment of a personal care product of the present invention.

FIG. 6 depicts a perspective view along section C-C in FIG. 5A of the upper handle end of an alternative embodiment of a personal care product of the present invention.

FIGS. 7A-7C depict three perspective views of a housing of the alternate embodiment in FIG. 5 of a personal care product having housing windows and struts in accordance with the present invention.

FIGS. 8A-8C depict three perspective views of a housing of an alternate embodiment of a personal care product having housing windows and struts in accordance with the present invention.

FIGS. 9A-9F depict three different fluid flow paths respectively in a front and rear perspective view of the embodiment in FIG. 5.

FIGS. 10A-10F depicts side and rear perspective views showing three different embodiments of floor surfaces of a housing of the present invention.

FIG. 11 depicts a personal care product of FIG. 5 of the present invention in use.

### DETAILED DESCRIPTION OF THE INVENTION

In the present invention, a personal care product comprises a treatment sheet with apertures disposed over an opening at the top of a housing at the upper end of the product. The housing comprises a cavity surrounded by a wall that comprises windows in the outer wall of the housing. The windows provide entry areas for rinsing fluid (e.g., water) for removing or rinsing away debris after use of the personal care product. The flow path through the windows and the apertures of the treatment sheet is multi-directional.

In addition, a frame member retains the treatment sheet on the housing portion of the personal care product. If tabs are present along the outer surface of the frame member, they can assist in securing the treatment sheet to the housing by being inserted into notches on upper ledges of the housing windows.

The treatment sheet at the top of the housing comprises a plurality of apertures. The apertures comprise non-straight sections along their inner perimeters. Portions of the inner perimeter of each aperture are being sharpened to provide a cutting edge. More durable cutting edges can be produced from materials like ceramic or crystals like silicon, sapphire, or diamond. These materials are not ductile like metal and often are brittle, i.e., fractures with little elastic deformation and without significant plastic deformation and thus they cannot be formed into e.g., a domed or convex shape but are planar sheets. This type of planar treatment surface increases the treatment efficiency such as the removal of hair or dermaplaning of skin on extended flat surfaces of skin such as legs, chest and back.

The term “product” as used herein includes an upper end and a lower end, wherein the upper and lower ends are either permanently or releasably coupled together. The upper end of the product of the present invention generally includes, but is not limited to, a treatment, a housing, sheet and a frame member.

The treatment sheet is desirably flat. A “flat” material generally has planar surfaces without protrusions or indentations. As used herein, “flat” and “planar” can be used interchangeably.

The treatment sheet is also desirably rigid. A “rigid” material signifies that the material is not flexible and cannot be easily bent.

The function of the treatment sheet in the personal care product is to both remove hair and to treat the skin and this is achieved by the structure of the treatment sheet noted above.

The treatment sheet of the present invention is desirably comprised of a solid, non-corroding material. The treatment sheet can be comprised of amorphous materials such as glass, crystalline materials such as silicon, diamond, sapphire, polycrystalline materials such as silicon, ceramic, or metals (e.g., steel), or any combination thereof. These materials can be shaped into rigid planar treatment sheets with apertures. Despite their rigidity, these materials can be fairly brittle. A “brittle” material is a material that generally fractures under load with little elastic or plastic deformation. The treatment sheet comprised of these materials, such as silicon and diamond, could shatter or break into pieces if the personal care product is dropped, if it is contacted with force, or takes the impact of a large force. The treatment sheet substrate can be comprised of a silicon material and the cutting edges can be comprised of a diamond material.

The term “housing” as used herein may include, but is not limited to, a structure at the upper end of a product. The housing in the present invention carries a treatment sheet and preferably comprises a cavity having windows bound by columns or struts. The housing generally has a substantially cylindrical shape though any feasible shape is contemplated by the present invention.

The term “debris” as used in accordance with the present invention may include, but is not limited to, dead skin cells, hairs (e.g., including terminal and vellus hair), treatment or shave preparations, dirt, oils, and other matter removed from the outer surface of the skin or applied to the surface of the skin prior and during use.

The term “cavity” as used herein signifies an open region or volume of the housing. The cavity preferably is a volume portion formed directly beneath the treatment sheet where debris from the use of the personal care product is collected, and removed easily (e.g., by rinsing with water). The debris may cling to the lower surface of the treatment sheet or fall into the cavity. The debris is removed from the lower surface of the treatment sheet of the cavity by flowing water, pressurized air, or by tapping the debris out through openings in the housing wall, or other feasible methods.

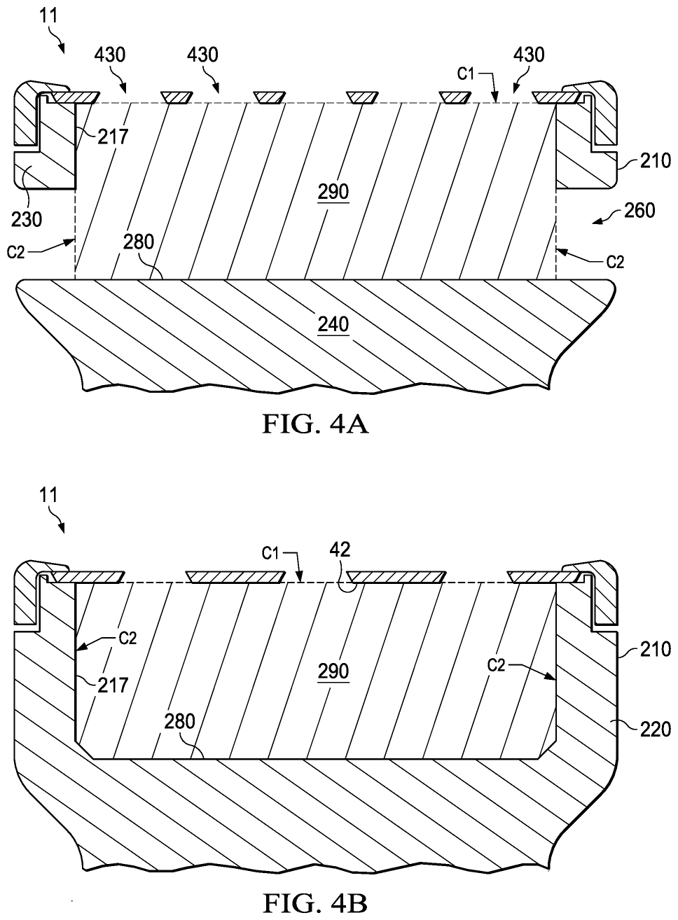

In the present invention, as shown in FIGS. 4A and 4B, the cavity 290 abuts a plane C1 defined by the lower surface 42 of the treatment sheet and generally extends along a plane C2 defined by the inner column wall 217 of the housing 20 (e.g., or the column) and extends to and over the floor surface 280 of the housing 20. For clarity, the volume of the cavity 290 is hatched in FIGS. 4A and 4B.

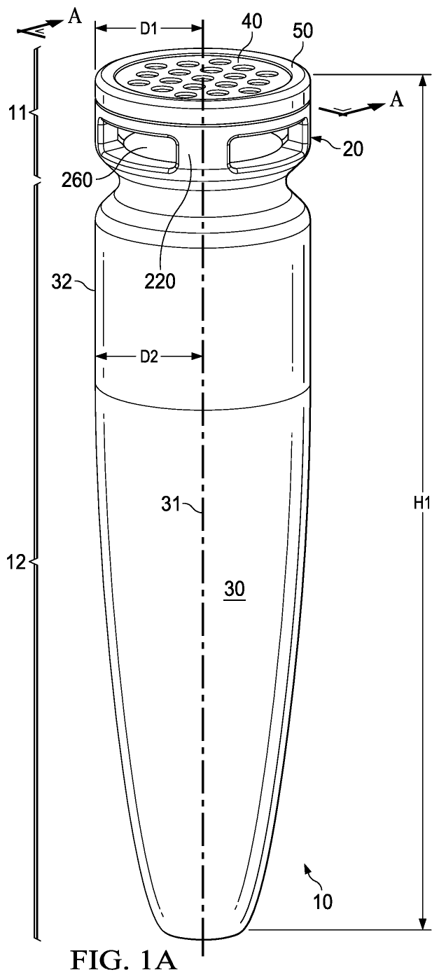

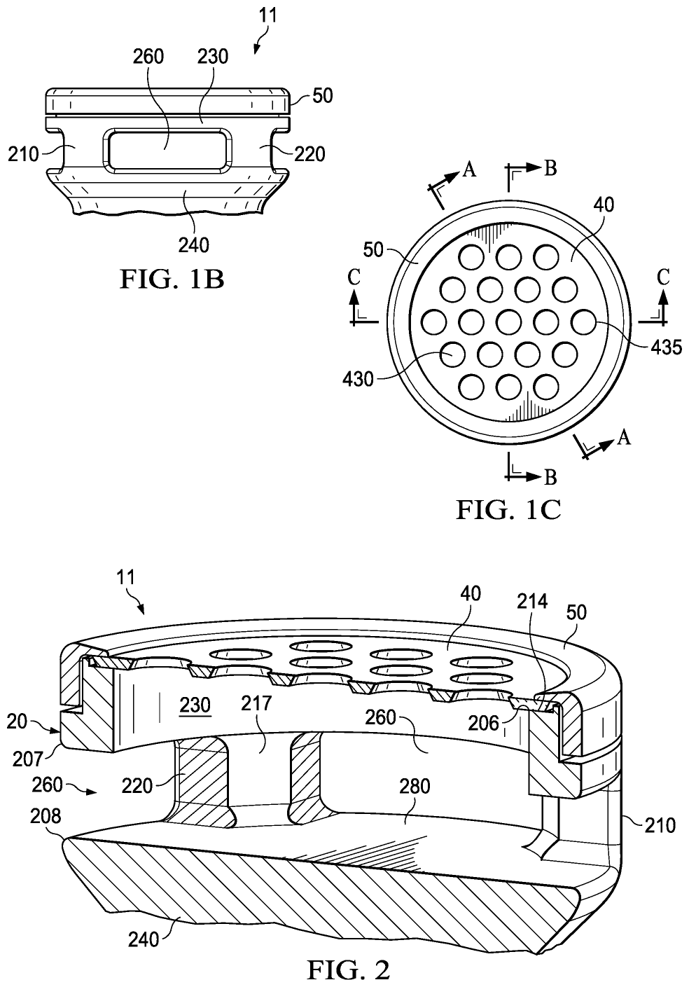

The cavity may comprise a height H2 of at least about one-fifteenth, or larger if feasible, of the height H1 (shown in FIG. 1A) of total length of the personal care product. The cavity comprises a height H2 at least about a height H3 of one of said plurality of columns and desirably the height H3 of the tallest column of said plurality of columns. Being immediately adjacent the treatment sheet and comprising such a large volume with windows in the housing wall, the cavity dramatically improves debris removal of the personal care product.

The term “window” or “windows” as used herein signifies the openings or apertures in the housing wall. Desirably the windows are cut out of, or formed integrally with, the outer wall of the housing. The windows may be formed such that they are not too far inward of the lower product end (e.g., the handle) so as to provide as large a cavity as possible. Desirably, the windows are formed along a surface that extends from the lower product end of the personal care product. The windows are flanked by columns or struts formed in the housing outer wall. The term “columns” and “struts” may be used interchangeably herein and generally flank the windows.

The windows are in communication with the cavity inside the housing. In this way, for instance, rinsing fluid can freely flow through one side of the windows through the cavity to the other side of the windows on the outside of the upper product end. Thus, when the personal care product is used and debris (e.g., cut hairs, dead skin cells, etc.) is collected from the action of the treatment sheet, the debris will be collected proximal to the treatment sheet (e.g., on the lower surface 42 of the treatment sheet), the debris located inside the cavity can easily be removed through the windows. Water or other cleaning fluids are preferred for removal of the debris, though other techniques such as pressurized air can also be used with the present invention windows. The size, shape, and location of the windows will be described in detail herein.

Described herein are polygonal and round shaped windows, however, any permutations of shapes and sizes of the housing windows are contemplated in the present invention. It follows that struts or columns that flank the windows may also have any shape, conformal to the windows or otherwise. Moreover, any feasible pattern and location of the windows or struts in the housing is also contemplated in the present invention.

The term “frame member” refers to a component on a personal care product, utilized in aligning and retaining the treatment sheet and as a skin contacting surface. The treatment sheet is aligned and disposed on an upper surface of the housing of the personal care product. For ease of understanding, the frame member can be considered to be a “frame” such as those used for photographs, and the treatment sheet can be considered to be the “glass” behind the frame. Using this metaphor, the shape of the frame member is preferably the same shape of the outer perimeter of the treatment sheet, but slightly larger.

The present invention contemplates an embodiment of a personal care product as shown in FIGS. 1 to 4. Referring to FIGS. 1A, 1B and 1C a perspective view, a top view and a side view of a personal care product 10 is shown comprising an upper product end 11 and a lower product end 12 comprising a handle 30. The upper product end 11 comprises a housing 20 having carrier 230, a base 240 and a side wall 210 with windows 260 separated or flanked by columns or struts 220. The carrier 230 has an uppermost surface 213 with a top opening 205. A treatment sheet 40 is disposed over a top opening of the housing 20 and a frame member 50 is disposed over the treatment sheet 40. The treatment sheet 40 has a generally round shape, though any shape is contemplated in the present invention. The treatment sheet includes apertures 430 in which cutting edges 435 are formed. The cutting edges in the treatment sheet function to remove hair and exfoliate skin of the user.

Windows 260 are openings in the side wall 210 of the housing of the present invention allowing for the removal of debris of cut hairs, shave preparation, dead skin cells, etc., that is collected during the operation of the personal care product. These windows 260 will be described in detail below.

FIG. 2 depicts a perspective view along section A-A in FIG. 1A of an upper product end 11 of a personal care product 10 including a housing 20 with windows 260 separated by struts 220. Though three windows 260 and two columns or struts 220 are shown in FIG. 2, any number of windows 260 and any number of struts 220 are contemplated in the present invention.

The housing also comprises an upper surface 214 with an inner perimeter 206 that surrounds the top opening 205 and a housing wall 210.

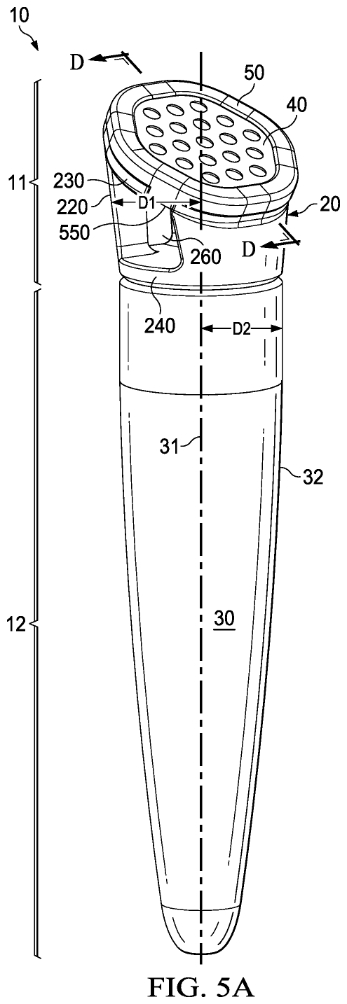

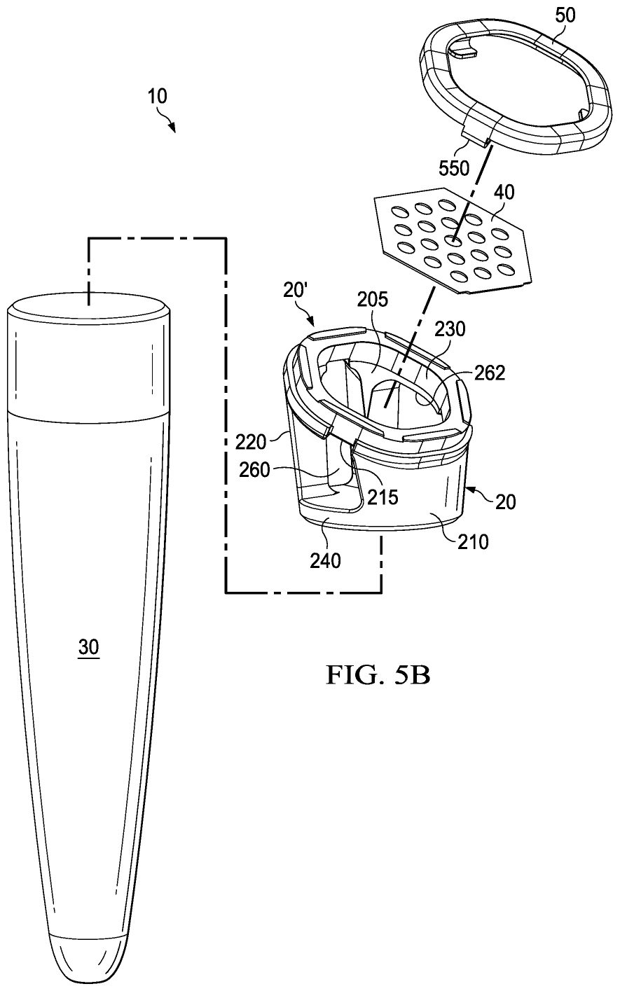

Tabs 550, if present on the frame member 50, can also be bent to extend around or into the housing wall 210 and into the housing windows 260. Tabs 550 are shown in FIG. 5, an alternate embodiment of the present invention.

The housing windows 260 serve to aid in rinsing the debris such as dead skin cells, shave preparation, or hairs (e.g., vellus hairs) produced or accumulated during use of the personal care product 10. Several embodiments of window shapes, sizes, and locations are described herein.

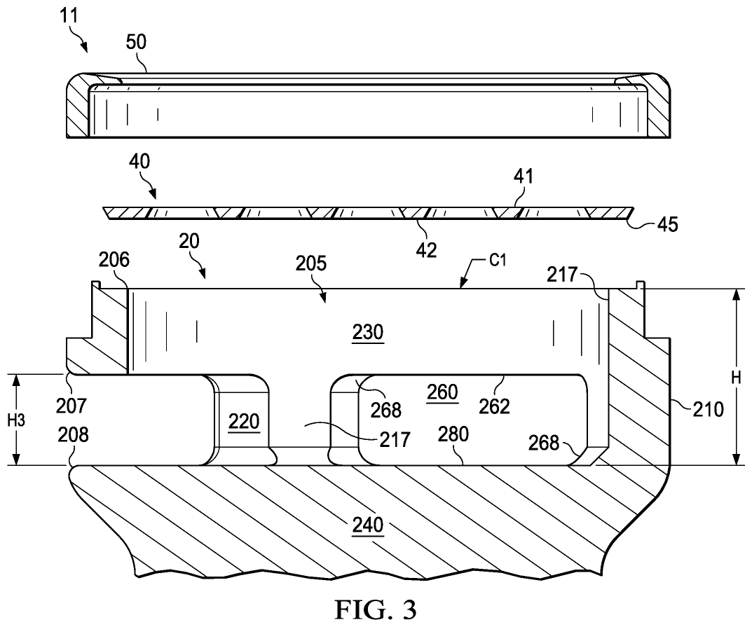

Referring to FIG. 3, depicts an exploded cross-sectional view taken along section B-B of FIG. 1C of an exploded cross-sectional view of the upper end of the personal care product 10 showing a housing 20, windows 260, struts 220, a treatment sheet 40, and a frame member 50 disposed thereon. As shown in FIG. 3, a carrier 230 of the holder 20 comprises a housing upper surface 214 which is configured to carry or hold the treatment sheet 40 in place. As shown, an outer portion of the lower surface 42 of the treatment sheet 40, at the perimeter 45 of the treatment sheet 40, contacts the housing uppermost surface 214. The carrier 230 also has lower ledge 262 which forms an upper ledge of the window 260.

Also shown in FIG. 3 is a base 240 with struts 220 disposed between the carrier 230 and the base in accordance with a preferred embodiment of the present invention. The outer surface of housing wall 210 extends from the lower outer perimeter 207 of the carrier 230 to the upper outer perimeter 208 of the base 240. The carrier and the base are generally parallel and the struts 220 are generally perpendicular to the both the carrier and the base, though any orientation of these components is contemplated in the present invention, for instance as shown in FIG. 5. In FIG. 3, struts 220 are hatched and are shown disposed between the floor surface 280 of the base 240 and the lower ledge 262 of windows 260. The struts 220 have a depth, width, and height. The height of the struts 220 in this embodiment generally defines the height of the windows 260.

Desirably, the windows 260 formed between the struts 220 have rounded corners 268 at the interface of the strut and the ledge 262 or the floor surface 280. By not being sharp (e.g., 90 degree) corners, the rounded corners 268 advantageously allow debris (e.g., collected under the treatment sheet 40 during use) to be removed easily out the windows by not remaining stuck in sharp corners.

Turning to FIGS. 4A and 4B, cross-sectional views taken along A-A and B-B of FIG. 1C, respectively, of an embodiment of an upper product end 11 of a personal care product 10 having housing windows 260 and struts 220 are shown. FIG. 4A depicts a cavity 290 of the present invention formed in a housing showing a cross-section along windows 260, while FIG. 4B depicts the housing showing a cross-section with struts 220.

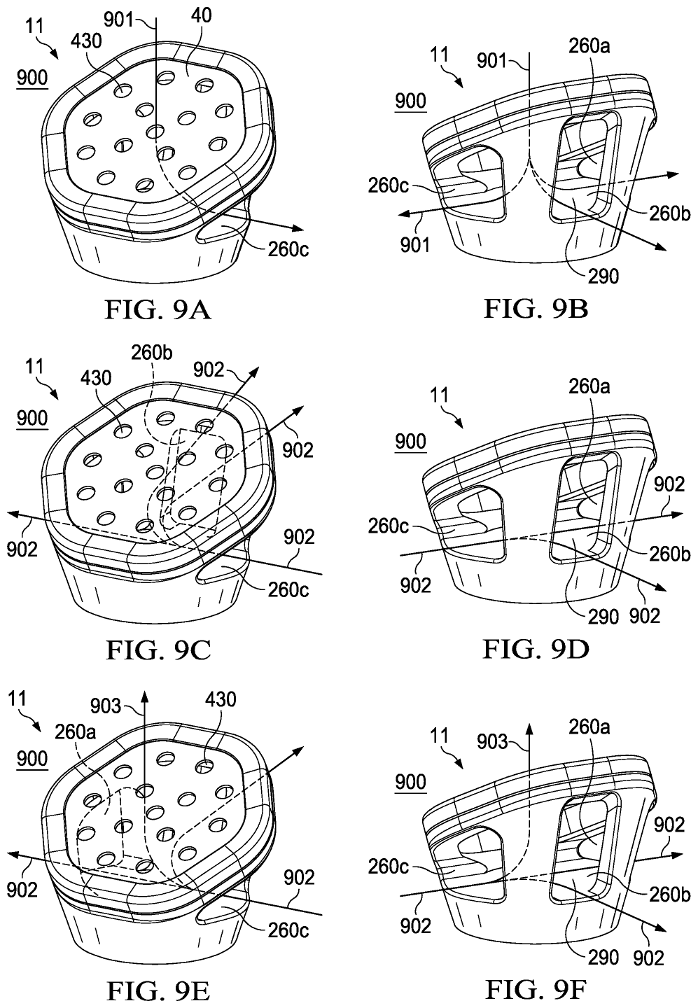

Cavity 290 in FIGS. 4A and 4B is shown abutting a plane C1 defined by the lower surface 42 of the entire treatment sheet 40, extending downward along a plane C2 defined by the inner column wall 217 of the housing 20, and extending to and over the floor surface 280 of the housing 20. For clarity, the volume of the cavity 290 is hatched in both FIGS. 4A and 4B. The cavity 290, being disposed directly under the treatment sheet (e.g., where debris falls through the apertures 430 of the treatment sheet 40), and the windows being disposed between the struts 220, allows for debris to be easily cleared, removed, or rinsed from the device. Debris removal is shown and described in more detail with regard to FIGS. 9A-9F.

FIG. 5A shows a perspective view and FIG. 5B depicts an exploded perspective view of an alternate embodiment of a personal care product of the present invention. In this embodiment, the treatment sheet 40 has a hexagonal shape and it is disposed over a top opening 205 of the housing 20. The carrier 230 is disposed at an angle relative to the base 240. The struts 220 are disposed between the carrier and the base, except in contrast to FIGS. 1 to 4, the struts 220 of FIG. 5 have varying dimensions, as will be described in more detail below.

Additionally, the frame member 50 of the embodiment in FIGS. 5A and 5B, comprises a plurality of tabs 550. The frame member 50 assists in aligning, placing, retaining and protection of the treatment sheet. The frame member 50 also serves as a skin contacting surface during use. The tabs 550 of the frame member 50 also assist in retaining the treatment sheet on the personal care product. The housing windows 260 as shown in FIG. 5, can serve to aid the tabs 550 of the frame member 50 in retaining the treatment sheet 40 on the housing 20, including but not limited to, through the use of a notch 215 formed in the upper ledge 262 of the window 260.

Desirably, the number of windows is equal to the number of tabs, though any number of contemplated windows and tabs are contemplated in the present invention. Several embodiments of window shapes, sizes, and locations are described below.

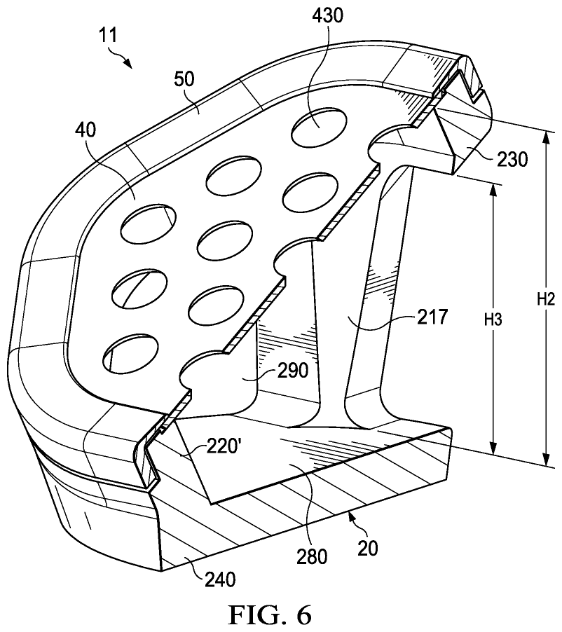

In FIG. 6, a cross-sectional cut view taken along line C-C of FIG. 5 depicts a portion of the cavity 290 and the housing inside wall 217 of the strut 220 of the product 10 in FIG. 5. In FIG. 6, the strut 220′ at the front of the personal care product is shorter than the struts 220″ in the remainder of the housing including those shown at the rear of the housing. This is due to the fact that the carrier 230 is angled relative to the base 240. Though no window 260 is present at the front of the housing 20 in FIG. 6, a small window disposed between two struts could be present if feasible.

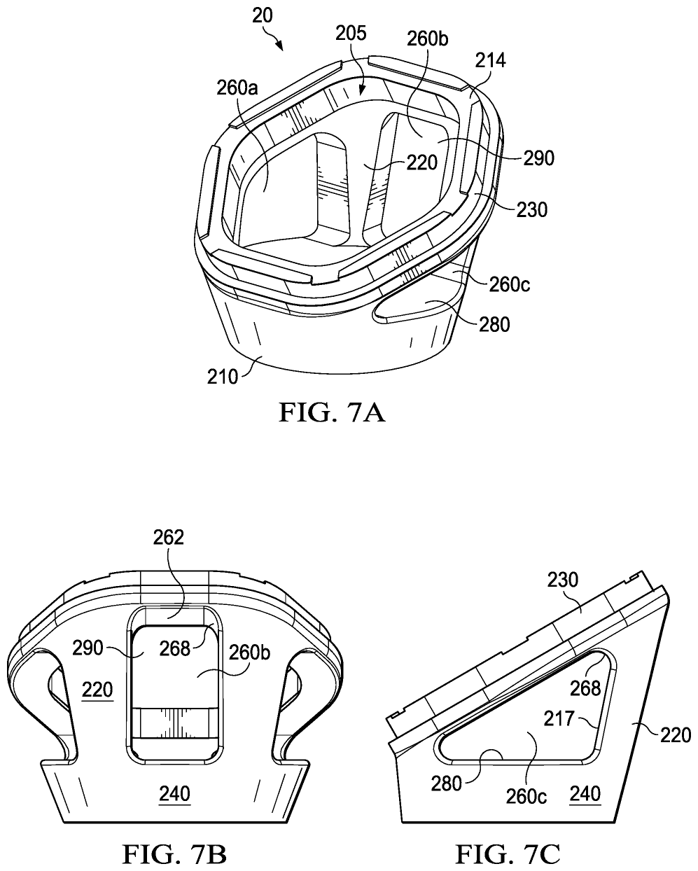

In FIGS. 7A to 7C, three views of a housing 20 with windows 260 of the embodiment in FIG. 5 of the personal care product of the present invention is shown. The housing 20 is shown detached from the lower product end 12, the treatment sheet 40, and the frame member 50 and with the top opening 205 exposed. There are three windows depicted in housing 20. Window 260a is on a left side, window 260b is on a rear side, and window 260c is on a right side of the housing 20. Window 260b, as shown in the rear view of the housing 20 of FIG. 7A, comprises a rectangular shape, whereas window 260a on the left side shown in FIG. 7B and window 260c on the right side of the housing 20 shown in FIG. 7C both have identical triangular shapes.

It is noted that the windows 260a, 260b, 260c desirably have rounded corners 268. By not having sharp edges, the debris is removed easier by the rinsing fluid and does not remain stuck in the cavity 290 at the sharp edges of the windows

Housing 20 also has an upper surface 214, one or more struts 220, and a floor surface 280. The columns 220 are disposed between the carrier 230 and the base 240 forming windows 260a, 260b, and 260c in the housing while also effectively forming part of the windows' “frame.” The floor surface 280 is shown as a flat, planar surface much like a floor in a home. The advantage of having a flat housing floor surface 280 is that window 260a on the left side of the housing has a “view” across to the other windows, 260b or 260c on rear and right sides of the housing. As debris is accumulated in the cavity 290 (e.g., beneath the treatment sheet 40), this “view” allows rinsing fluids like water to flow without obstruction from one window to another rinsing away the debris. Further, as this floor surface 280 is a flat, solid surface, adjacent to the lower product end 12, it blocks any debris from getting into the handle interior. The present invention contemplates that the floor surface 280 of the housing may be comprised of any shaped surface as opposed to a flat surface, embodiments of which will be described below.

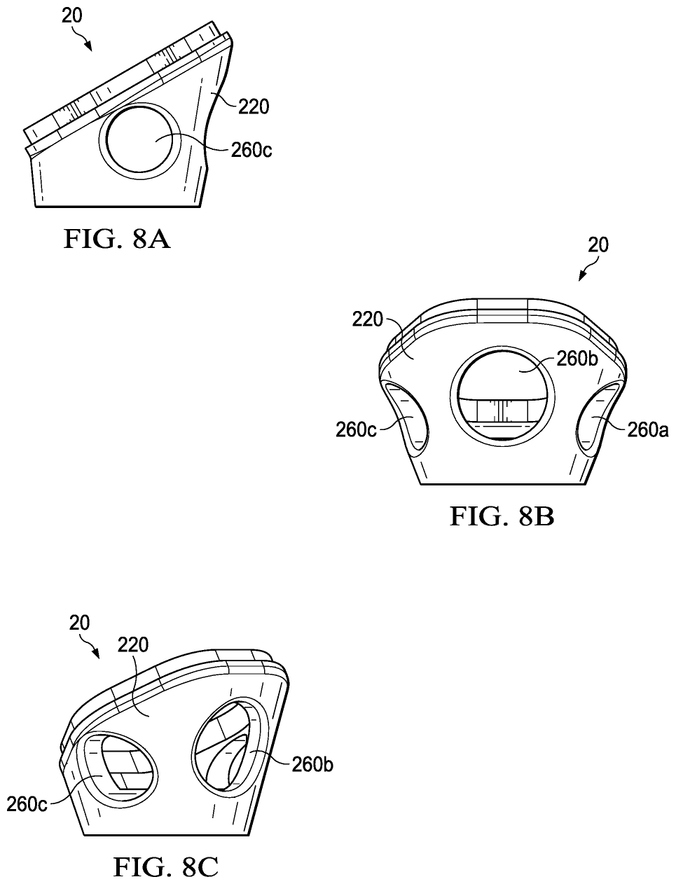

FIGS. 8A to 8C depict three perspective views of an alternate embodiment of a personal care product having a housing 20′ with windows and struts in accordance with the present invention. There are three windows 260a′, 260b′ and 260c′ in FIGS. 8A to 8C each of which have a circular or round shape. While they are all the same shape, the sizes are different in that the window in the rear of the housing is larger than the windows on the left and right sides. Here, as with FIGS. 5 to 7, there is no window at the front of the housing. The round shaped windows provide easy debris removal.

Turning now to FIGS. 9A to 9F, the various paths of flow for debris removal through the housing windows and treatment sheet of the present invention embodiment of FIGS. 5 to 7. are shown. A rinsing agent is desirable for debris removal including but not limited to water, a cleaning agent such as alcohol or surfactant solution, or a gas, such as air or pressurized gases. Regardless of type of rinsing agent, the flow path for debris removal is generally the same. In FIG. 9A, the flow path 901 is shown initiating from the external environment 900 and into the top of the treatment sheet, through the apertures 430 of the treatment sheet, into the cavity 290, and out the side window 260c. Thus, the rinsing agent can be poured or inserted from the top of the treatment sheet 40 to be sent through the apertures 430 and into the cavity 290 to flush out the debris in the cavity that has collected underneath the treatment sheet 40 and out through the window 260c. In FIG. 9B, the flow path 901 of FIG. 9A is shown from the rear side of the upper product end 11, starting from the top of the treatment sheet 40, flowing through the apertures 430, into the cavity 290, and out of any or all of the windows, 260a, 260b, and 260c.

In FIG. 9C, a second flow path 902 is shown where a rinsing agent initiates from side window 260c and flows out the side window 260a directly opposite of window 260c. The flow path can initiate from any of the windows and remove debris from beneath the treatment sheet and through any of the other windows. For instance, the rinsing agent may initiate from side window 260a and flow out the side window 260c.

In FIG. 9D, the flow paths of FIG. 9C are shown from the rear perspective of the upper product end 11. As is shown, the flow path 902 initiates flow of the rinsing agent from side window 260c and flows out the side window 260a directly opposite of window 260c and/or rear window 260b. Again, the flow may have initiated from side window 260a or rear window 260b and been removed out of any of the remaining windows.

In FIG. 9E, the second flow path 902 of FIG. 9C is shown where a rinsing agent initiates from side window 260c and flows out the side window 260a directly opposite of window 260c. The flow path can initiate from any of the windows and remove out any of the other windows. For instance, the rinsing agent may initiate from side window 260a and flow out the side window 260c. In addition, a third flow path 903 also initiating from side window 260c and flowing into the cavity 290 and then up through the apertures 430 and out into the external environment 900. In FIG. 9F, the flow paths of FIG. 9E are shown from the rear perspective of the upper product end 11. As is shown, the flow path 902 initiates flow of the rinsing agent from side window 260c and flows out the side window 260a directly opposite of window 260c or rear window 260b. The flow path 903 of FIG. 9E is shown in FIG. 9F from the rear perspective, initiating from side window 260c and flowing into the cavity 290 and up through the apertures 430 of the treatment sheet to the external environment 900. Here too the rinsing agent flow path may have been initiated from any of the windows and then removed through the apertures.

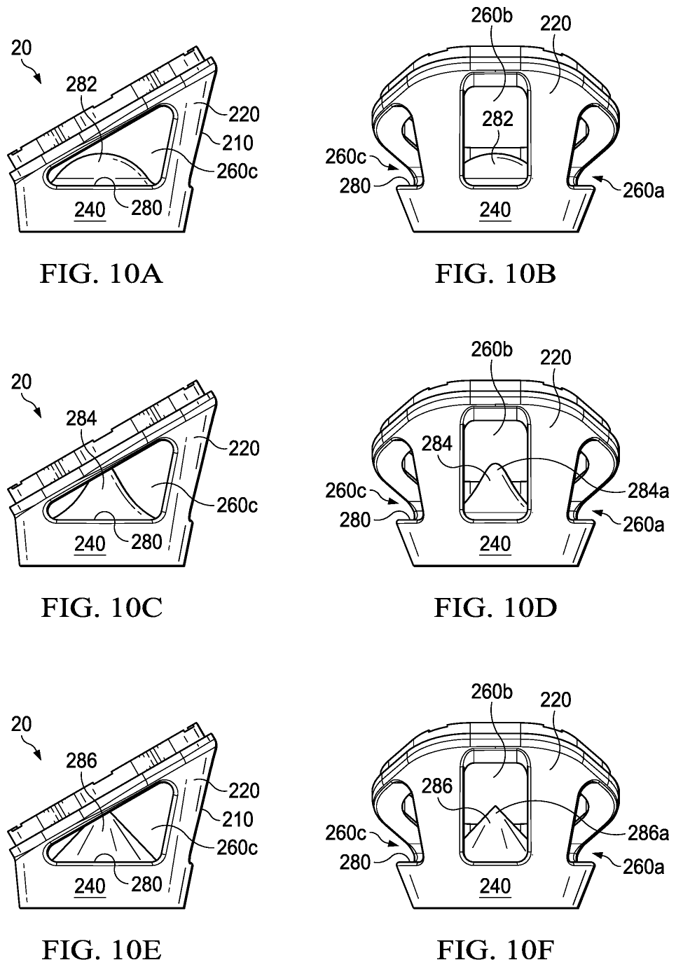

While the floor surface 280 has been described thus far as being flat and solid (e.g., much like a floor in a home), the present invention contemplates a floor surface having one or more curved surfaces. For instance, several shapes may be incorporated onto the floor surface of the personal care product housing of the present invention. Turning to FIGS. 10A to 10F, three alternate embodiments for floor surfaces of the present invention are shown. In a first alternate embodiment shown in FIGS. 10A and 10B, side and rear views of a housing have a floor surface 280 comprising a dome shaped protrusion 282 projecting from a center area of the floor surface 280. The dome shaped protrusion 282 desirably comprises a portion of a spherical shape, such as a half-sphere. The dome shaped protrusion 282 extends upwards into the cavity 290 from the floor 280 such that the dome shaped portion is directed towards the treatment sheet 40 and the base of the dome shape is disposed on the floor surface 280. As can be seen in FIG. 10B, the dome shaped protrusion 282 does not have a height or width that would block the window 260b or any of the other windows, which is desirable to maintain efficient debris removal. By having a dome shaped protrusion 282 formed in this way, as debris is rinsed away from the underside of the treatment sheet and from within cavity, the flow path of rinsing agent and debris is directed downward to slide over the dome shaped protrusion and out the windows 260a, 260b, and 260c, just as with a flat floor surface, but in this case having a dome shaped protrusion further expedites drainage for expelling fluid and debris removal. Equally for rinsing agent entering through any of the windows 260a, 260b, and 260c, the flow path of rinsing agent and debris is directed upward to clear the debris the treatment sheet.

In a second alternate embodiment shown in FIGS. 10C and 10D, side and rear views of a housing have a floor surface 280 comprising a funnel shaped protrusion 284 projecting from a center area of the floor surface 280. The funnel shaped protrusion 284 has an apex desirably of conical shape or a portion of a funnel. The funnel shaped protrusion 284 extends upwards into the cavity 290 from the floor 280 such that the apex is directed towards the treatment sheet 40. As can be seen in FIG. 10D, the funnel shaped protrusion 284 does not have a height or width that would block the window 260b or any of the other windows. This is desirable to maintain efficient debris removal. By having a funnel shaped protrusion 284 formed in this way, as debris is rinsed away from the underside of the treatment sheet and from within cavity, the flow path of rinsing agent and debris is directed downward to slide over the exterior surfaces of the funnel shaped protrusion 284 and out the windows 260a, 260b, and 260c, just as with a flat floor surface, but in this case, having a funnel shaped protrusion further expedites drainage for expelling fluid and debris removal.

In a third alternate embodiment shown in FIGS. 10E and 10F, side and rear views of a housing have a floor surface 280 comprising a cone shaped protrusion 286 projecting from a center area of the floor surface 280. The cone shaped protrusion 286 having an apex 286a desirably comprises a conical shape or a portion of a cone, such as a top portion of a cone comprising the apex. The cone shaped protrusion 286 extends upwards into the cavity 290 from the floor 280 such that the apex is directed towards the treatment sheet 40. As can be seen in FIG. 10F, the cone shaped protrusion 286 does not have a height or width that would totally block or obstruct the window 260b or any of the other windows. This is desirable to maintain efficient debris removal. By having a cone shaped protrusion 286 formed in this way, as debris is rinsed away from the underside of the treatment sheet and from within cavity, the flow path of rinsing agent and debris is directed downward to slide over the exterior surfaces of the cone shaped protrusion 286 and out the windows 260a, 260b, and 260c, just as with a flat floor surface, but in this case, having a cone shaped protrusion further expedites drainage for expelling fluid and debris removal.

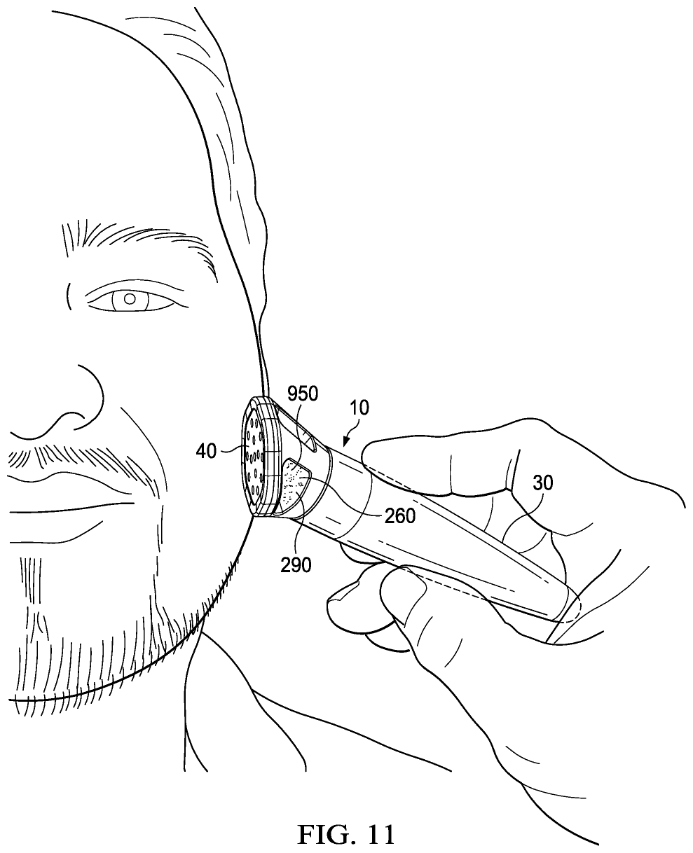

FIG. 11 shows the personal care product 10 while in use on the skin of a user. As can be seen, a user is holding the handle 30 of the personal care product 10 of the present invention on a portion of their face. Treatment sheet 40 is held toward and up against the skin such that as the product is moved up, down, and around over the skin of a user, removal of hairs and exfoliation of the skin dermis occurs. Debris 950 is collected under the treatment sheet 40 and in the housing cavity 290. This debris is subsequently removed using a rinsing agent and the flow paths as described in FIGS. 9A to 9F.

Any other feasible arrangements of windows and other components in the personal care product are also contemplated by the present invention.

The illustrations presented herein are not intended to be actual views of any particular substrate, apparatus (e.g., device, system, etc.), or method, but are merely idealized and/or schematic representations that are employed to describe and illustrate various embodiments of the disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” The term “about” as used herein generally signifies approximately or around. As one example, when a range of numerals are given, e.g., if “about 4 to about 40” is or “4 to 40” is disclosed herein, the present invention contemplates the recited value of “4” and “40” and a functionally equivalent range surrounding each of the 4 and the 40, which can generally be plus or minus 10 percent of each number. Thus, for clarity, if a reference is described as being “4 to 40” this signifies it could be a functionally equivalent range of 4 and a functionally equivalent range of 40 or “about 4 to about 40.” The latter signifies the range of “3.6 to 44” as being encompassed by the present invention since the range of 3.6 to 4.4 represents plus and minus 10 percent of 4, respectively and the range of 36 to 44 represents plus and minus 10 percent of 40, respectively.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover, in the appended claims, all such changes and modifications that are within the scope of this invention.

What is claimed is:

1. A personal care product comprising
a treatment sheet having a lower surface;
a housing comprising a floor surface and a plurality of columns; and
a cavity formed by a volume extending from said lower surface to said floor surface.

2. The personal care product of claim 1 wherein said volume extends from an inner column wall of said housing.

3. The personal care product of claim 1 wherein said plurality of columns is formed in a side wall of said housing.

4. The personal care product of claim 1 wherein said cavity is empty.

5. The personal care product of claim 1 wherein said cavity comprises a height H2 of at least one-fifteenth of a height H1 of said personal care product.

6. The personal care product of claim 1 wherein said cavity comprises a height H2 at least about a height H3 of one of said plurality of columns.

7. The personal care product of claim 1 wherein said treatment sheet is flat.

8. The personal care product of claim 1 wherein said treatment sheet is brittle.

9. The personal care product of claim 1 wherein said plurality of columns extends upward from said floor surface of said housing.

10. The personal care product of claim 9 wherein said plurality of columns extends to a lower ledge of a carrier of said housing.

11. The personal care product of claim 1 wherein said floor surface is parallel relative to a plane C1 defined by said lower surface.

12. The personal care product of claim 1 wherein said floor surface is angled relative to a plane C1 defined by said lower surface.

13. The personal care product of claim 1 wherein said floor surface is flat or shaped.

14. The personal care product of claim 11 wherein said shaped floor surface comprises a dome or a cone shape.

15. The personal care product of claim 1 further comprising one or more windows disposed between said plurality of columns.

16. The personal care product of claim 13 wherein said treatment sheet is proximal to said one or more windows.

17. The personal care product of claim 13 wherein said treatment sheet is visible from said one or more windows.

18. The personal care product of claim 1 wherein said housing is substantially cylindrical.

19. The personal care product of claim 1 wherein fluid flows within said cavity.

20. The personal care product of claim 15 wherein said fluid flows into and out of said one or more windows.
